(19) United States
(12) Patent Application Publication
(10) Pub. No.: US 2003/0076242 A1
(43) Pub. Date: Apr. 24, 2003

(54) Utility meter having computer network access for receiving an interpretive language program to implement new meter functionality

(76) Inventors: Gordon R. Burns, West Lafayette, IN (US); William Jenrette, Raleigh, NC (US)

Correspondence Address: David M. Lockman, Maginot, Moore & Bowman, Bank One Center/ Tower, 111 Monument Circle, Suite 3000, Indianapolis, IN, 46204-5115, US

(21) Appl. No.: 10/255,138

(22) Filed: Sep. 25, 2002

Related U.S. Application Data
(60) Provisional application No. 60/325,031, filed on Sep. 25, 2001.

(51) Int. Cl. H04M 11/00; G08C 15/06

(52) U.S. Cl. 340/870.02; 379/106.03

(57) ABSTRACT

A utility meter is able to receive programs for adding functionality to the meter over a computer network. The meter includes an interpreter for executing an interpretive language program and a computer network access port for receiving an interpretive language program from another computer over a computer network. The interpreter executes the interpretive language program to provide a meter function for the utility meter. In one embodiment, the interpreter is a Java Virtual Machine that interprets Java applets or Java scripts. The ability to write meter functions in a machine independent language such as Java or Active X enables utility customers to write and download additional functionality to meters over the Internet without requiring the meter manufacturer to develop a meter function program.

This application claims the benefit of U.S. Provisional Application No. 60/325,031 filed Sep. 25, 2001.

### FIELD OF THE INVENTION

The present invention relates to utility meters, and in particular, to utility meters that include one or more programmable processors to perform meter functions.

### BACKGROUND OF THE INVENTION

Utility meters, for example, electrical utility meters, often employ microprocessors to obtain comprehensive information regarding the consumption of the commodity by the facility or system to which the utility meter is connected. In the past, mechanical counter-type meters could only provide limited information such as the accumulated total quantity of electricity, gas, or water consumed. However, current processor-based meters have the capability to perform usage analysis such as load-profiling as it is known in the electricity metering industry, demand analysis to identify high demand periods during a day or a month, time of use metering to evaluate cost rates that vary according to the time of day, and diagnostics of both the meter and the system to which it is connected. Various remote meter reading functions may also be controlled by a processor.

In the case of electricity meters, such advanced capabilities still require fundamental metering measurements, such as voltage, current, energy and reactive energy. The processing device uses the fundamental measurement information (and a real-time clock if necessary) to perform any or all of the above advanced functions.

One problem facing the industry is that with so many functions available, there is a need to allow energy customers and/or utilities to define what functions they desire their meters to perform. Energy customers typically fall into one of three classes: high end users, commercial users, and residential users. High end users are typically energy producers who want to monitor energy parameters at distribution nodes and switching yards. Commercial users include manufacturing facilities as well as office and retail complexes that have a meter for each machine on a manufacturing line or a meter for each tenant, respectively. Residential users are single family dwellings with meters for measuring usage on a billing cycle basis.

Existing high-end meters may be customized using an extensive set of control tables. These tables control how the meter processes data, what calculations it performs, and what outputs it produces. These functions include the time and date with support for daylight savings time, time of use rates, total usage monitoring, rate calculations, a list identifying the items to be displayed by the meter, and timing parameters for relay control. The table driven method is an improvement over the previous industry practice, which was to write custom software to perform all of these functions.

However, there are drawbacks with the table approach. In particular, programming a multitude of different functions is a complex job. Custom software is necessary to assist meter users (both utilities and their customers) with the programming/selecting task. Second, the job of checking every user selection in the entire set of control tables in order to determine whether to perform each of the various functions requires an extensive amount of computational time and program memory space. Third, in order to add any new feature, the software stored in the meter needs to be modified. Software modification is not trivial and may lead to the introduction of bugs. Also, adding a new program to a meter requires installing the program into the meter by some mechanism. One mechanism for installing a program to perform a new function is to build new meters with memory devices that store the new programs and then exchange the new meters for old meters. The old meters may then be upgraded by installing memory devices containing the new programs. Another method for installing new software into meters requires a service person to make a service call to a meter and download software from a portable memory device carried by the service person to the meter. Both of these methods are expensive as they require service calls. Furthermore, meters have a limited amount of physical space for memory. Once a program memory card is filled, the meter either requires a redesign to hold more program memory or existing programs need to be removed from memory so other programs may be stored in the memory.

Another limitation of providing new functionality into existing utility meters involves the ability and incentive to generate programs to implement new functionality in a meter. For example, a manufacturing facility or electric utility has an engineering staff that is knowledgeable about the manufacturing process and desirous of acquiring information about energy consumption, use, load fluctuations, or the like on the line. Thus, these engineers are probably the best persons to develop programs for implementing the new functionality. However, the engineers of the meter manufacturer are the ones who are required to write the programs for the new functionality because they are most knowledgeable about the computer resources and operating environment in the meter. Consequently, information must be exchanged between the engineering staff of the utility customer and the utility meter manufacturer in order for the new functionality to be implemented. Even if this exchange occurs efficiently, the utility meter manufacturer may not have the incentive to develop the program because the demand for the new version of the meter would be insufficient to warrant the cost of development and the administration of the new meter version.

What is needed is a way of providing new functionality in a utility meter without requiring service calls.

What is needed is a way of providing new functionality in a utility meter without requiring deletion of existing programs from the memory of the meter.

What is needed is a way of providing new functionality in a utility meter without requiring manufacture of a new version of a meter.

### SUMMARY OF THE INVENTION

The above problems are addressed by providing a utility meter with a computer network access port for receiving an interpretive language program to implement new functionality for the meter. The program may perform some (or all) of the meter functions. The interpretive language program may be an applet program written in an interpretive language such as Sun Microsystem's Java® or Microsoft's Active X® language. The meter processing circuitry receives a set of inputs from the signal processing components of the meter. Those inputs may include energy (watt-hours), reactive energy (VAR-hours), as well as voltage and current values for each phase being metered. The applets may employ one or more of those standard inputs to perform a metering function.

The utility meter comprises a memory for storing programs that are executed by the utility meter, an interpretive language program stored in the memory, an interpreter for executing the interpretive language program, and a computer network access port for receiving an interpretive language program and storing it in the memory. The interpreter may then execute the interpretive language program to provide new functionality for the utility meter. The ability to receive and store an interpretive language program that may be executed by the interpreter to provide a meter function allows the meter to temporarily store and execute the interpretive language program. After the program has been executed to provide the meter function, the memory where the program is stored may be used to store other programs or data. If the meter function provided by the interpretive language program is required again, the program may be executed from memory, if it is still resident, or provided through the network access port for temporary storage and execution. Thus, the program that provides the meter function need not remain in the meter's memory for subsequent performance.

In one embodiment of the present invention, the interpreter is a Java Virtual Machine. The interpretive language program executed by a Java Virtual Machine is a Java applet. Because Java is a well known interpretive programming language that does not require knowledge of the computer on which the Java Virtual Machine is executing, interpretive language programs that provide utility meter functions may be written by qualified personnel of a utility or a utility's customers. These programs may then be provided to the meter through the computer network access port for execution at the meter. Thus, the engineers and programmers who support and develop programs for the utility meter manufacturer need not be involved in the development of interpretive language programs to provide meter functions desired by a utility or a utility customer.

The computer network access port of the present invention may comprise a computer network interface and a communication driver. The communication driver receives messages for a local port for the meter that corresponds to a local I/O port for a personal computer (PC) and converts the messages to a network protocol for the computer network interface. This component of the present invention may be used to accept data from existing programs stored on the utility meter and provide it to a computer network interface for communication to another computer on a computer network. Thus, the computer network access port of the present invention allows the utility meter to appear as a computer on a computer network without requiring re-engineering of the meter function application programs on the meter to enable communication with a computer network interface. Instead, the computer network access port is installed in the meter so that communication directed to local I/O ports are received by the communication driver and converted for computer network interface communication. In one embodiment of the present invention, the local I/O port protocol is an RS-232C compatible protocol and the computer network interface encapsulates data messages in a TCP/IP protocol for transmission to an Ethernet 10 Base T local area network (LAN) or wide area network (WAN). Alternatively, the computer network access port may include a telephone modem with an appropriate modem driver. The modem driver communicates data messages between programs executing on the meter and the modem. The modem communicates over the voice and/or digital portions of the telephone network. Thus, a computer device having a modem may call a number that may be accessed by the meter to initiate communication with the modem at the meter and download an interpretive program to the meter. Likewise, the meter may use its modem to call a telephone number associated with a computer device and initiate communication with the modem at the device to download data or request an interpretive program download.

According to the principles of the present invention, the method includes receiving an interpretive language program at a utility meter from another computer coupled to a computer network, storing the interpretive language program in a memory of the utility meter, and executing the interpretive language program to perform a meter function. Receipt of the interpretive language program includes receiving an interpretive language program through a computer network access port and converting the interpretive language program to a local I/O protocol for storage on the utility meter.

It is an object of the present invention to allow programs for implementing meter functionality to be developed by a utility or its customers.

It is an object of the present invention to couple utility meters to a computer network for communication of data and programs between at least one computer on the network and at least one meter.

It is an object of the present invention to provide meter functionality in interpretive language programs so that the program may be executed by an interpreter for at least one implementation of the meter functionality.

These and other advantages and features of the present invention may be discerned from reviewing the accompanying drawings and the detailed description of the invention.

### BRIEF DESCRIPTION OF THE DRAWING

The present invention may take form in various system and method components and arrangement of system and method components. The drawings are only for purposes of illustrating exemplary embodiments and are not to be construed as limiting the invention.

FIG. 1 shows an exemplary system according to the invention that includes a meter operable to receive interpretive language programs via a computer network.

FIG. 2 shows the components of the utility meter of FIG. 1 that execute the interpretive language program and support communication with the computer network;

FIG. 3 shows a system incorporating the meter of the present invention to modify the functionality of meters monitoring energy usage parameters of machines in a facility; and

FIG. 4 shows an exemplary method of providing meter functionality at a utility meter through an interpretive language program communicated through a computer network access port.

### DESCRIPTION OF THE INVENTION

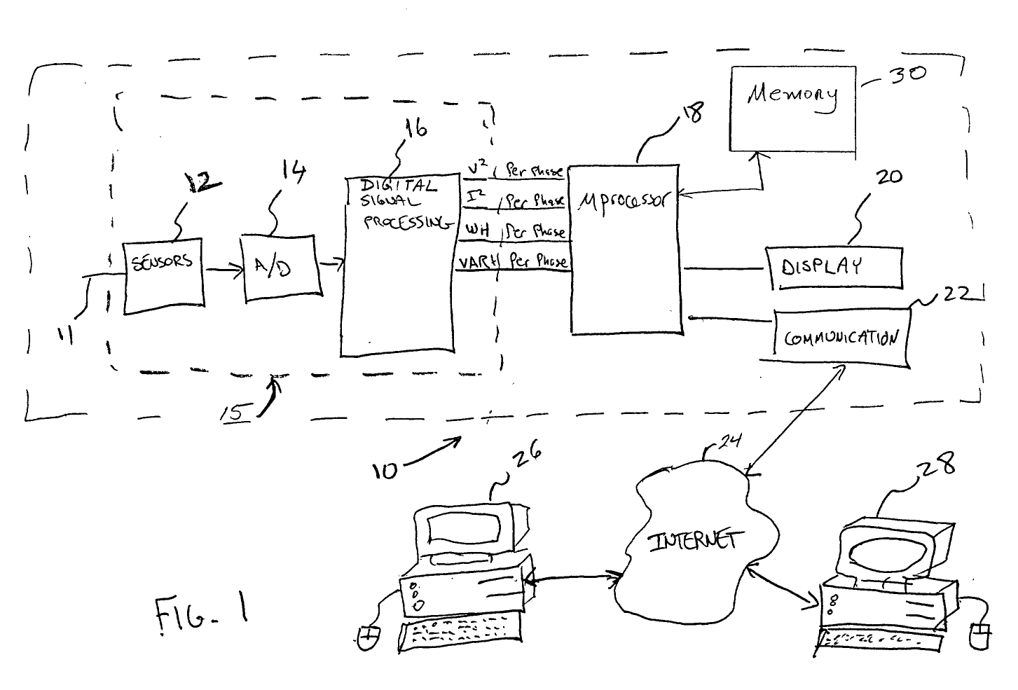

FIG. 1 shows an exemplary system in which the present invention may be implemented. The system includes a meter 10 that operates in accordance with the principles of the present invention. Meter 10 is communicatively coupled to a plurality of external computers, exemplified by external computers 26 and 28, via a computer network 24, such as the Internet. Of course, network 24 may be any computer network such as a local area network (LAN) or wide area network (WAN) that supports communication between computers on network 24 and meter 10.

Meter 10 includes a signal processing component 15, a processor 18, a display 20 and a communication circuit 22. Meter 10 may also include other communication circuits that employ other communication networks, such as private wire-line networks, radio and/or cellular networks, or the like. Such devices allow for remote meter reading, reporting of power outages, and other functions, as known in the art.

Signal processing component 15 is operable to measure a consumed quantity and generate basic consumption data therefrom. In the exemplary embodiment of an electricity meter described herein, the basic consumption data may suitably include voltage information, current information, energy information (watt-hours), and reactive energy information. By way of example, signal processing component 15 includes one or more voltage and current sensors 12, one or more A/D converters 14 and a digital signal processor 16. Further detail regarding suitable signal processing elements of meters may be found in U.S. Pat. No. 6,043,642 and U.S. Pat. No. 5,627,759, both of which are incorporated herein by reference. Electricity is often provided in multiple phases. Accordingly, voltage and current sensors 12, A/D converters 14 and digital signal processor 16 may be configured to generate the basic consumption data for each phase as taught by U.S. Pat. No. 6,043,642 and U.S. Pat. No. 5,627,759.

Signal processing component 15 provides the basic consumption data to processor 18. Processor 18 in previously known meters executes meter function programs persistently stored in memory 30 to generate various metering totals and perform various meter functions using the basic consumption data. Such functions may include time-of-use metering, demand metering, various types of diagnostics, load profiling, harmonic analysis, power quality metering and other types of meter functions known in the art. Processor 18 may display information derived from the performance of the meter functions on display 20. Memory 30 may include persistent storage units such as EEPROM or the like as well as volatile memory such as RAM. In previously known meters, meter function programs are stored in persistent memory and executed by processor 18 to perform meter functions. In support of this execution, variable data may be stored in the volatile portion of memory 30 as these data are generated and/or modified. Thus, the only way to provide additional meter functions in a meter is to develop a computer program to implement the new meter function, compile and assemble the program to generate a load module, and store the load module in a persistent memory unit for installation in a meter. As discussed above, different users may require different sets of such functions to be operational within a meter. Providing different configurations of meter functions around a core set of meter functions is difficult with these previously known meters because different sets of persistent memory units had to be maintained for various versions of the meters.

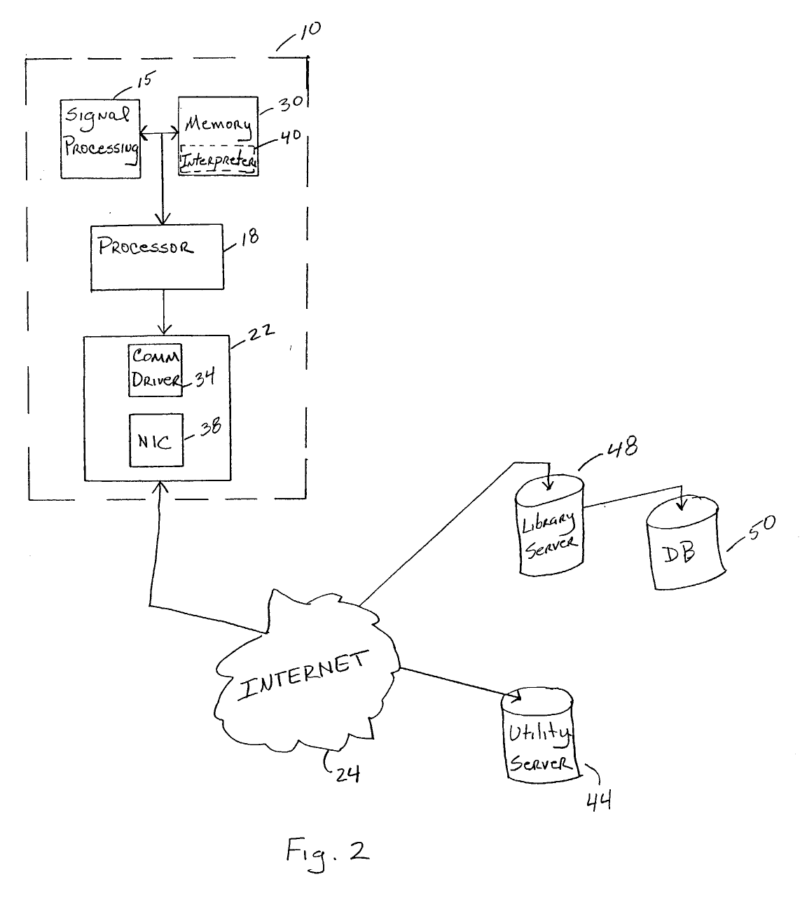

To provide a meter 10 with an additional meter function without requiring storage of the program implementing the function in a persistent memory unit, communication circuit 22 of meter 10 includes a communication driver 34 and a computer network interface 38 as shown in FIG. 2. Communication circuit 22 of FIG. 2 provides meter 10 with a computer network access port through which another computer may provide an interpretive language program that is implemented by interpreter 40 stored in memory 30. Interpreter 40 is an interpreter such as JWorks written for the 186 family of processors that is available from Wind River, Inc. of Alameda, Calif. A Java Virtual Machine may be used to interpret Java applets and Java script programs. Other processors or interpretive language programs/interpreters may be used such as an interpreter for Active X language programs. While interpretive language programs execute more slowly than compiled programs, they are machine independent. Thus, they may be sent to a meter, temporarily stored in volatile memory, and interpreted by the interpreter. The results obtained from executing the function implemented by an interpretive program may be temporarily stored or they may be returned via communication circuit 22 to a computer coupled to network 24. The interpretive program may be deleted after it is executed. Also, interpretive language programs may be sent to a meter 10 with an identified execution time. The interpretive language program may be stored and the interpreter invoked at the identified execution time so the meter function may be performed at the appropriate time. The results may then be sent to a computer coupled to the network or temporarily stored for later transmission.

Processor 18 executes meter function programs that may be stored in non-volatile or persistent memory in meter 10. This method of meter operation is well known. Many such applications were developed to provide data obtained from a meter function to a local input/output (I/O) port. For example, data obtained from a meter function may be temporarily stored until a service person retrieved the data through an optical port or RS232C port that was typically accessible through a DB-9 connector. The service person typically carried a handheld meter reader or portable personal computer (PC) that also had an optical port or RS-232C port. By bringing the reader or PC into proximity to the meter and activating I/O operations through the local port, data was obtained from meter 10 and stored in the reader or PC. As a result, many meter functions stored in existing meters are programmed to communicate through local I/O ports at the meter.

To retain the functionality provided by these previously programmed meter functions and take advantage of the communication access to computer network 24, a communication driver 34 is provided to interface communications between application programs executed by processor 18 and computer network interface 38. Communication driver 34 receives messages from application programs executed by processor 18 and communicates with computer network interface 38 in a known manner so network interface 38 encapsulates the data message in a known computer network protocol. Likewise, communication driver 34 receives data messages for meter 10 from network interface 38 and converts them into a protocol and format compatible with local I/O ports so the application programs can receive the message. Preferably, the communication driver 34 is the Embrace Micro Client software driver available from Embrace Networks, Inc. of Napierville, Ill.

Alternatively, the computer network access port may include a telephone modem with an appropriate modem driver. The modem driver communicates data messages between programs executing on the meter and the modem. The modem communicates over the voice and/or digital portions of the telephone network. Thus, a computer device having a modem may call a number that may be accessed by the meter to initiate communication with the modem at the meter and download an interpretive program to the meter. Likewise, the meter may use its modem to call a telephone number associated with a computer device and initiate communication with the modem at the device to download data or request an interpretive program download.

As shown in FIG. 2, a utility company may develop interpretive language programs and provide them through a server 44 and network 24 to a meter 10. Meter 10 may be provided a program in response to the operating system of meter 10 initiating a communication session with server 44. After verifying the meter's authorization to receive a program, server 44 may return an interpretive language program. For example, a meter 10 may access a telephone line at the site where the meter is installed through communication circuit 22 and connect with an Internet service provider to establish a communication session with server 44. Server 44 may respond by incorporating an interpretive language program within an HTML form and returning the form to meter 10. The operating system may then provide the interpretive language program to interpreter 40 or store it for later execution by interpreter 40. Results obtained from the execution of the interpretive language program may be communicated to driver 34 and driver 34 may provide the results in an HTML form to network interface 38 for transmission to server 44. An operating system for a meter made in accordance with the principles of the present invention may be a Vx Works operating system that is available from Wind River, Inc. of Alameda, Calif.

In another embodiment of the present invention, an interpretive program developed by a utility company may be transmitted through network 24 to a library server 48. Library server 48 may be coupled to one or more databases 50. A database 50 may be used by server 48 to store interpretive language programs for delivery to a meter 10. Thus, server 44 may provide interpretive language programs to server 48 for storage on a database 50 and server 48 may retrieve and send one or more programs to a meter 10 in response to a meter establishing a communication session with server 48. Additionally, a meter 10 may provide its data to server 48 for storage in a database 50. Periodically, server 44 may communicate with server 48 to obtain the results of a database mining of the portion of database 50 storing meter data or server 44 may receive an update of meter data stored at server 48. Preferably, the library server is an Embrace Device Brokerage Platform server available from Embrace Networks, Inc. of Napierville, Ill.

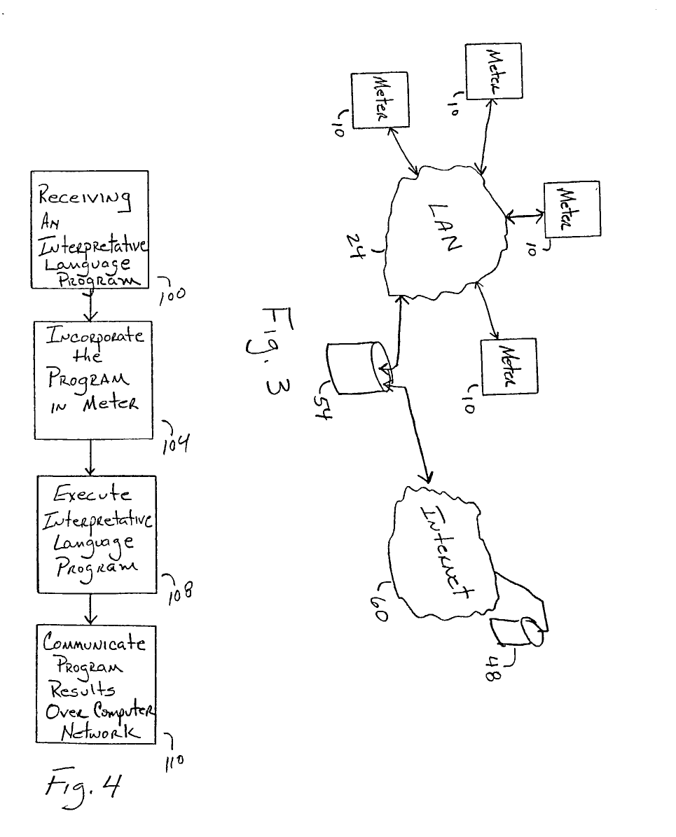

In the system shown in FIG. 3, a meter 10 is coupled through a computer network 24 to a facility server 54. In this example, network 24 is a LAN or WAN for coupling computers throughout a facility, such as a manufacturing facility. Interpretive language programs developed by the engineering staff of the facility may be communicated to one or more meters coupled to network 24. Alternatively, server 54 may obtain an interpretive language program from a library server 48 through computer network 60, which may be the Internet. The execution of the interpretive language programs by the interpreters 40 in the meters 10 provides data that may be communicated to server 54 for storage and analysis. In this manner, a facility may be able to more flexibly monitor energy usage parameters at various manufacturing machines without having to install new meter functions in the persistent memory of a meter.

For example, a facility may wish to update meter 10, which is programmed for energy measurement only, to also perform an apparent energy measurement (VA). Personnel for the facility would write (or obtain from a library server 48) an interpretive language program for calculating VA. Such a program would, as stated above, be written to use the available signal processing inputs to the processor 18. Server 54 would download the program to processor 18 through network 24 and communication circuit 22. Alternatively, an interpretive language program that includes the existing functions of the meter 10 plus the additional VA calculating functionality may be provided to meter 10 through network 24. The operating system at meter 10 may then incorporate the new VA routine into the operations of meter 10. Thereafter, processor 18 would execute compiled programs as before and use interpreter 40 to execute the interpretive language program. Meter 10 may now determine both real energy consumption (as before) and apparent energy consumption (VA), as modified. The VA consumption information may be stored, displayed, or communicated through network 24 to another computer on the network depending upon the instructions of the interpretive language program.

A method of the present invention is shown in FIG. 3. The method includes receiving an interpretive language program that implements a meter function and interpreting the program to perform the meter function. Receipt of the program includes receiving a data message containing the interpretive language program from a computer coupled to a computer network (block 100). The interpretive language program is incorporated within the functions to be performed by meter 10 and stored in local memory (block 104). This action may also include setting a timer for later execution of the function or making a table entry in the task table for performance of meter functions within a meter as is well known. At the appropriate time, interpreter 40 executes the interpretive language program (block 108) to perform the meter function. The results may be stored for later transmission or meter 10 may establish a communication session with a computer on network 24 for transmission of the results contemporaneously with obtaining the measurement results. As may be determined by the interpretive language program or the table structure of the meter, the measurement results are incorporated in a data message and sent over the computer network (block 110).

While the present invention has been illustrated by the description of exemplary processes and system components, and while the various processes and components have been described in considerable detail, applicant does not intend to restrict or in any limit the scope of the appended claims to such detail. Additional advantages and modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed:

1. A utility meter comprising:
a memory for storing programs that are executed by the utility meter;
an interpretive language program stored in the memory;
an interpreter for executing the interpretive language program; and
a computer network access port for receiving an interpretive language program and storing it in the memory so that when the interpreter executes the interpretive language program it provides new functionality for the utility meter.

2. The meter of claim 1 wherein the interpretive language program is a Java applet.

3. The meter of claim 1 wherein the interpretive language program is a Java script program.

4. The meter of claim 1 wherein the interpreter interprets Java language programs.

5. The meter of claim 1 wherein the interpreter interprets Active X programs.

6. The meter of claim 1 wherein the computer network access port comprises:
a communication driver for communicating with programs executing in the memory of the meter; and
a computer network interface for communicating with a computer network.

7. The meter of claim 6 wherein the communication driver converts data messages between an RS-232C protocol and a TCP/IP protocol.

8. The meter of claim 6 wherein the computer network interface communicates data messages to a computer network implementing a 10 Base T protocol.

9. The meter of claim 1 wherein the interpreter interprets Active X language programs.

10. The meter of claim 1, the computer network access port further comprising:
a modem for communicating with a computer device over a telephone network; and
a modem driver for communicating between the modem and programs executing on the meter.

11. A method for adding a meter function to a utility meter comprising:
receiving an interpretive language program at a utility meter from another computer coupled to a computer network;
storing the interpretive language program in a memory of the utility meter;
and
executing the interpretive language program to perform a meter function.

12. The method of claim 11 wherein the receipt of the interpretive language program receives a Java applet.

13. The method of claim 11 wherein the receipt of the interpretive language program receives a Java script program.

14. The method of claim 11 wherein the execution includes interpreting Java language programs.

15. The method of claim 11 wherein the execution includes interpretating Active X programs.

16. The method of claim 11 further comprising:
communicating network data received from the computer network with programs executing in the memory of the meter; and
communicating meter data obtained from meter functions over a computer network.

17. The method of claim 16 wherein the network data communication converts data messages between an RS-232C protocol and a TCP/IP protocol.

18. The method of claim 17 further comprising:
communicating data messages between the meter and a computer device over a telephone network.

19. The method of claim 11 wherein the interpretation interprets Active X language programs.

20. The method of claim 11 wherein the receipt of the interpretive language program includes:
receiving an interpretive language program through a computer network access port; and
converting the interpretive language program to a local I/O protocol so the program may be stored on the utility meter.
